(19) United States
(12) Patent Application Publication
(10) Pub. No.: US 2025/0052496 A1
(43) Pub. Date: Feb. 13, 2025

(54) FLEXIBLE BAFFLE

(71) Applicant: FIBERBUILT MANUFACTURING INC., Calgary (CA)

(72) Inventors: Dan FLETCHER, Calgary (CA); Michael HOOPER, Calgary (CA); Meghan WEIR, Calgary (CA)

(21) Appl. No.: 18/799,741

(22) Filed: Aug. 9, 2024

Related U.S. Application Data
(60) Provisional application No. 63/518,638, filed on Aug. 10, 2023.

(51) Int. Cl. F26B 25/00

(52) U.S. Cl. CPC F26B 25/008

(57) ABSTRACT

A baffle, comprises: a sealing portion including a first sheet of flexible sheet material and a second sheet of flexible sheet material overlying the first sheet of flexible sheet material to define a stack, each of the first sheet and the second sheet including a base edge, a plurality of flaps extending from the base edge and a V-shaped notch between each adjacent pair of flaps, the plurality of flaps of the first sheet being aligned with the V-shaped notches of the second sheet in the stack; and a retainer coupled to the sealing portion, the retainer securing the first sheet and the second sheet along the base edges.

### CROSS REFERENCE TO RELATED APPLICATION

This application claims the benefit of provisional U.S. Application No. 63/518,638 entitled “Flexible Baffle” filed Aug. 10, 2023, the technical disclosure of which is incorporated herein by reference in its entirety.

### FIELD

The present invention relates generally to a flexible baffle. In particular, the invention relates to a flexible baffle, a flexible baffle installation and a kiln with the flexible baffle installation.

### BACKGROUND

Baffles are employed as seals to segment areas within a space. Baffles are employed to direct fluids through a selected path and act against fluid transfer therethrough from one area to another. Flexible baffles are useful where objects must be moved past the baffle and into an area. The flexible baffle can flex to allow the object to move therepast, but can still create a seal against the object.

In the lumber industry, lumber is dried in a kiln. Lumber is moved into the kiln in a stack called a charge. The stack of lumber, called a charge, may be on a conveyance such as a conveyor, moveable platform or rail car. Depending on the set up of the kiln, the charge may be moved into and out of the kiln through a single door or there may be two aligned doors to the kiln, and the charge moves along in one door and out the other.

Baffles in the kiln create seals against the charge so that fluids such as air, gas, mist and vapour are forced through a selected path past and through the lumber. The baffles need to be flexible to allow the charge move past the baffle without damaging the baffle or dislodging/disrupting the lumber, while maintaining a seal. The baffle for a kiln must also be constructed of durable, such as heat and acid resistant, materials, so they don't readily break down in the kiln. For example, kilns are known to be quite acidic and some kilns have been operated at temperatures of up to 300° F. Further, over time, the kiln drying process generates a thick coating of pitch on all interior surfaces. Any baffle must have a useful life in these conditions.

### SUMMARY

The present invention provides a flexible baffle, a baffle installation for a kiln and a kiln with a baffle.

In accordance with one aspect of the present invention, there is provided a flexible baffle comprising: a sealing portion including a first sheet of flexible sheet material and a second sheet of flexible sheet material overlying the first sheet of flexible sheet material to define a stack, each of the first sheet and the second sheet including a base edge, a plurality of flaps extending from the base edge and a V-shaped notch between each adjacent pair of flaps, the plurality of flaps of the first sheet being aligned with the V-shaped notches of the second sheet in the stack; and a retainer coupled to the sealing portion, the retainer securing the first sheet and the second sheet along the base edges.

In accordance with another aspect, there is provided a baffle installation baffle installation, comprising: a first baffle and a second baffle, each of the first baffle and the second baffle having a length extending from a first end to a second end; a sealing portion including a plurality of sheets of flexible sheet material overlying one another in a stack, each of the plurality of sheets including a base edge and a plurality of flaps extending from the base edge and a V-shaped notch between each adjacent pair of flaps, the flaps of one sheet aligned with the notches of an adjacent sheet in the stack; and a retainer coupled to the sealing portion, the retainer securing the plurality of sheets along the base edges; the second end of the first baffle being adjacent to the first end of the second baffle.

In accordance with yet another aspect, there is provided a kiln. The kiln comprises: a chamber with a doorway; the doorway being positioned to create a path through which a charge may be introduced to the chamber; a baffle installation, disposed on an inner surface of the chamber, the baffle installation including: a first baffle and a second baffle, each of the first baffle and the second baffle having a length extending from a first end to a second end; a sealing portion including a plurality of sheets of flexible sheet material overlying one another in a stack, each of the plurality of sheets including a base edge and a plurality of flaps extending from the base edge and a V-shaped notch between each adjacent pair of flaps, the flaps of one sheet aligned with the notches of an adjacent sheet in the stack; and a retainer coupled to the sealing portion, the retainer securing the plurality of sheets along the base edges; the second end of the first baffle being adjacent to the first end of the second baffle.

In accordance with another broad aspect, there is provided a method for drying a charge, the method comprising: inserting the charge into a chamber; the chamber having a baffle installation according to the above broad aspect disposed therein, thereby segmenting the chamber into a first zone on a first side of the baffle installation and a second zone on a second side of the baffle installation; the baffle installation being positioned to create a seal against the charge; and flowing a fluid from the first zone through the charge into the second zone

It is to be understood that other aspects of the present invention will become readily apparent to those skilled in the art from the following detailed description, wherein various embodiments of the invention are shown and described by way of illustration. As will be realized, the invention is capable for other and different embodiments and its several details are capable of modification in various other respects, all without departing from the claim scope of the present invention. Accordingly, the drawings and detailed description are to be regarded as illustrative in nature and not as restrictive.

### BRIEF DESCRIPTION OF THE DRAWINGS

Referring to the drawings, several aspects of the present invention are illustrated by way of example, and not by way of limitation, in detail in the figures, wherein:

FIG. 1A is a front elevation of a baffle according to the present invention;

FIG. 1B is a front, side perspective view of the baffle of FIG. 1A;

FIG. 1C is a side elevation of the baffle of FIG. 1A;

FIG. 1D is the detail A, from FIG. 1C;

FIG. 2A is a plan view of a sheet segment useful in the baffle of FIG. 1A;

FIG. 2B is a front, side perspective view of the baffle sheet of FIG. 2A;

FIG. 2C is a side elevation view of the baffle sheet of FIG. 2A;

FIG. 3A is a front elevation of another baffle according to the present invention;

FIG. 3B is a front, side perspective view of the baffle of FIG. 3A;

FIG. 3C is a side, elevation view of the baffle of FIG. 3A;

FIG. 3D is the detail A, from FIG. 3C;

FIG. 3E is a plan view of a sheet segment useful in the baffle of FIG. 3A;

FIG. 4A is a front elevation of another baffle according to the present invention;

FIG. 4B is a front, side perspective view of the baffle of FIG. 4A;

FIG. 4C is a side elevation of the baffle of FIG. 4A;

FIG. 4D is a top plan view of the baffle of FIG. 4A;

FIG. 5 is a front, side perspective view of another baffle according to the present invention;

FIG. 6A is an end, side perspective view of a charge of wood in a kiln with a baffle installation according to the present invention, the walls of the kiln are removed;

FIG. 6B is an end view of the kiln of FIG. 6A;

FIG. 7A is an end, side perspective view of a charge of wood in another kiln with another baffle installation, according to the invention, the walls of the kiln are again removed;

FIG. 7B is a side elevation of the kiln of FIG. 7A;

FIG. 7C is a top plan view of the kiln of FIG. 7A; and

FIG. 7D is the detail A, from FIG. 7C.

### DETAILED DESCRIPTION OF VARIOUS EMBODIMENTS

The description that follows and the embodiments described and illustrated therein, are provided by way of illustration of an example, or examples, of particular embodiments of the principles of various aspects of the present invention. These examples are provided for the purposes of explanation, and not of limitation, of those principles and of the invention in its various aspects. In the description, similar parts are marked throughout the specification and the drawings with the same respective reference numerals. The drawings are not necessarily to scale and in some instances proportions may have been exaggerated in order more clearly to depict certain features.

The invention relates a baffle for controlling movement of fluids in an area, while being flexible and resilient to create a seal against an object moved therepast. While the baffle may be used in various industries, it is useful in the lumber industry. For example, the baffle may be employed in a kiln for treatment of wood.

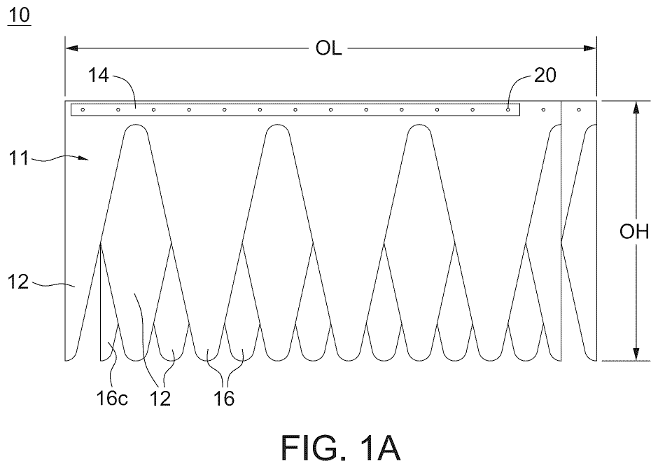

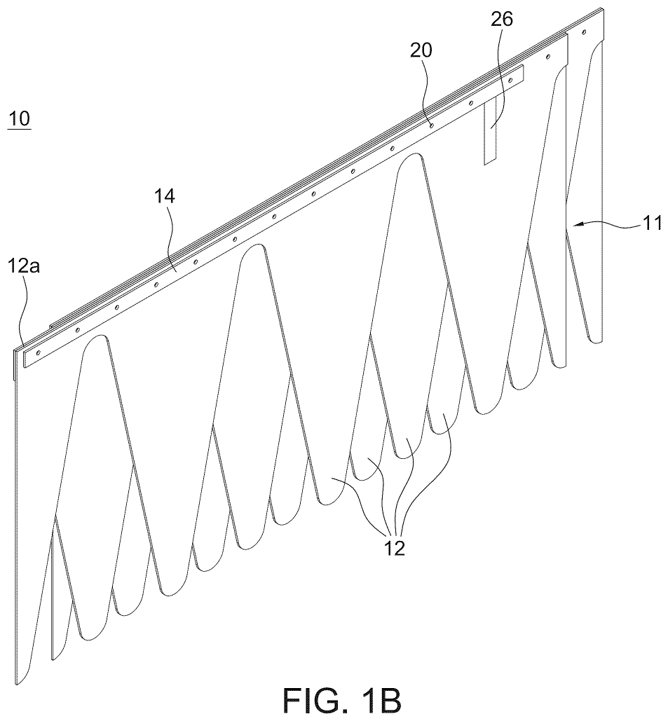

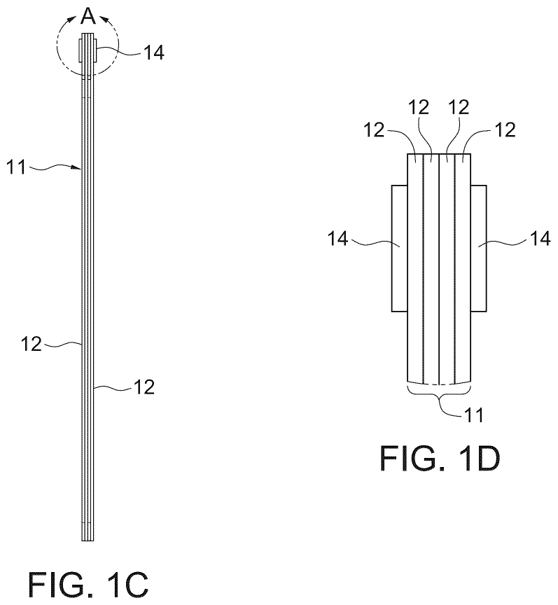

With reference to FIGS. 1A to 1D, an example baffle 10 is illustrated. Baffle 10 includes a seal portion 11 and a retainer 14. The seal portion includes a plurality of sheets 12 of resilient material clamped together at their base edges 12a with the retainer 14. Baffle 10 can be mounted along its edge via the retainer 14 and while the seal portion 11 extends out to define a flexible seal against an object.

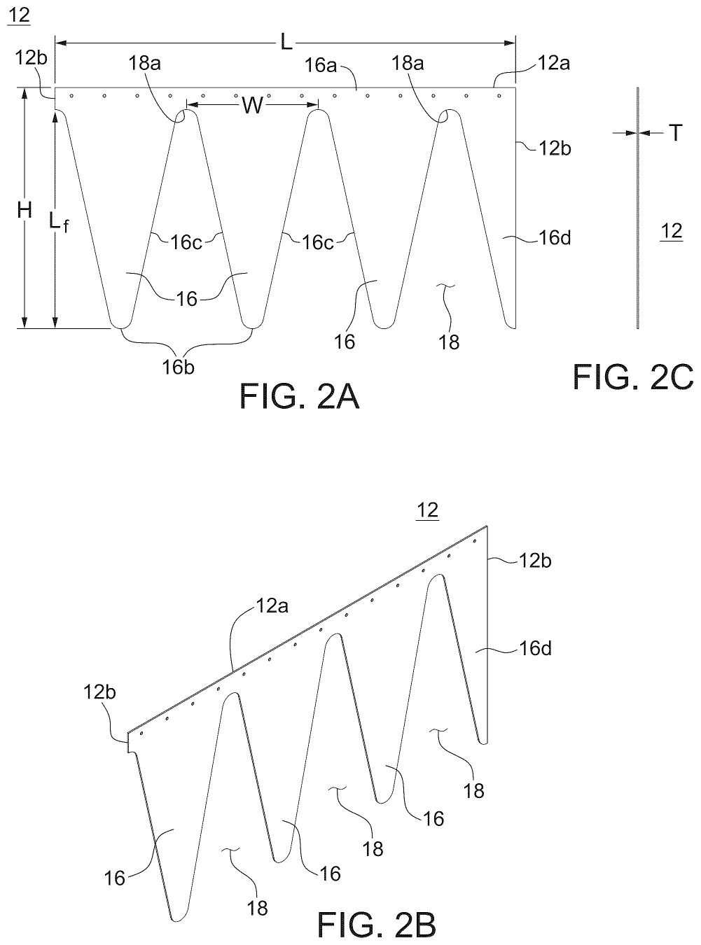

The sheets in a baffle may be similar or identical. A sheet 12 from baffle 10 is illustrated in FIGS. 2A to 2C. Each sheet 12 has a length L along its base edge 12a, a height H, measured orthogonal to the length L, and a thickness T. Each sheet has a plurality of flaps 16 extending from the base edge 12a between end edges 12b. The flaps extend out and in part define the height H of the sheet.

Each flap of the plurality of flaps has a base end 16a, which is coupled to the base edge 12a of the sheet, a tip 16b and a pair of side edges 16c extending from the base end to the tip. The distance between the side edges 16c tapers from the base end 16a to the tip 16b. As such, there are V-shaped spaces or notches 18 between the flaps along the length L of the sheet.

The tips of the plurality of flaps may be blunt, rounded or pointed. The illustrated sheet of FIG. 2A has flaps with rounded tips 16b. A sheet with a rounded or pointed tips tends to operate better than blunt ended flaps for some baffles, as will be discussed herein below.

The side edges 16c of adjacent flaps come together in a valley 18a of the notch 18 between to two adjacent flaps. The distance from valley 18a to adjacent valley 18a may be defined as the width W of the flap and the distance, orthogonal to the base edge, from valley to tip may be defined as the length Lf of the flap.

On a sheet, most or all of the flaps may be of similar shape with a similar width and similar flap length.

The sheets are each constructed of flexible, resilient sheet material. To be clear, a sheet implies that the thickness dimension between a front planar side and a rear planar side of the material is much less than the width and length dimensions. The resiliently, flexible sheet material can be selected from sheet-form rubber, sheet form synthetic rubber, sheet form polymers, etc. The sheet material may include any one or more of: heat resistant additives, fillers, reinforcement fibers, etc. The sheet material may have a substantially solid thickness between its front planar side and its rear planar side across its entire surface area. The sheet material provides for the separation and isolation of the fluids between the front side and the back side of the sheet.

In one embodiment, the sheet material may be stiffer near base edge 12a, than at the opposite edge. This may be by selective use of reinforcements or other stiffening means.

To construct a baffle, a plurality of the sheets are positioned with their base edges aligned. The sheets may have similarly shaped flaps, such that the flaps of one sheet can be positioned in the notches of another sheet of the plurality of sheets employed to construct one baffle. Stated another way, the plurality of sheets 12 can be stacked with the tips of their flaps offset from one sheet to the next, such that the flaps of one sheet extend under the notch of another sheet. In one embodiment, a baffle has at least three sheets with flaps stacked to construct a baffle. In the construction, the flaps of the second sheet are positioned with their valleys centered on the flaps of the first sheet and the third sheet is positioned with its flap tips extending in the spaces between the tips of the first and second sheets.

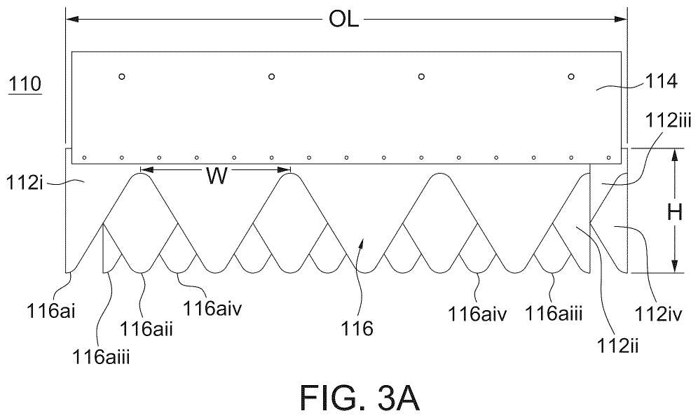

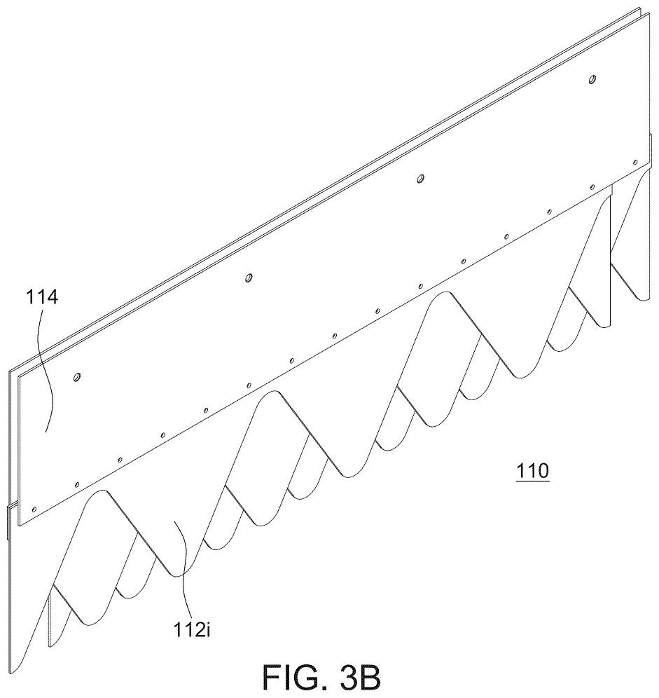

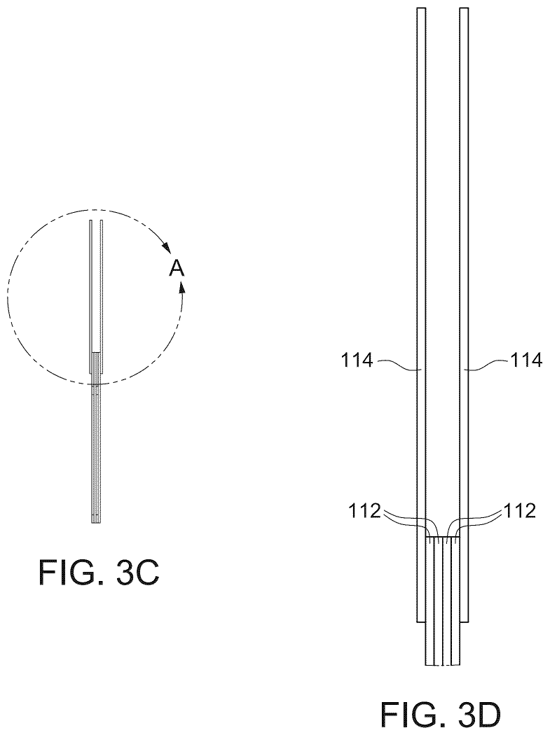

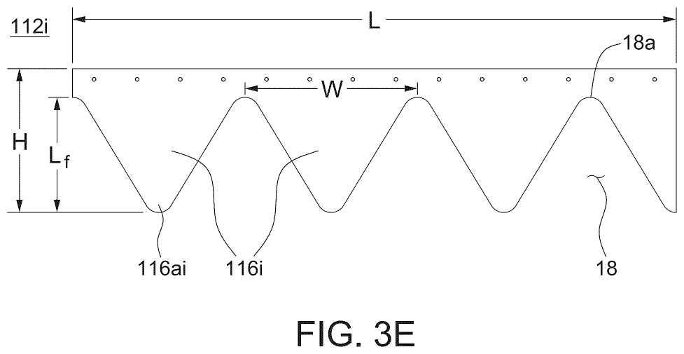

While the embodiment of FIG. 3A to does differ in some ways from the FIGS. 1A to 1D, it is useful to exemplify the baffle construction. For example, the baffle 110 of FIGS. 3A to 3D includes four identical sheets 112i, 112ii, 112iii, 112iv connected by a retainer 114. The second sheet 112ii has its flap tips 116aii offset about ½ of the width W from the tips 116ai of the first sheet 112i; the third sheet 112iii has its flap tips 116aiii offset about ¼ of the width from the tips of the first sheet 112i; and the fourth sheet 112iv has its flap tips 116aiv offset about ¾ of the distance D from the tips of the first sheet 112i. As such, all the tips of the four sheets are substantially equally spaced along the flexible seal side of the baffle 110. The four sheets are secured together via the retainer 114.

In one embodiment, there is a half flap 16d on one end of the sheet 12. The half flap 16d has a taper and length Lf similar to the other flaps 16 on the sheet but it is cut along its width at the tip.

In particular, flap 16d has a width of ½ W, compared to the other flaps. This half flap facilitates the stacking of the sheets in the baffle, with the spaced tips and without having the end edges of all of the sheets out of alignment. This multi-layer and offset construction ensures full baffle coverage and an effective seal.

In one embodiment, the end edges 12b of at least some of the sheets are out of alignment in a staggered fashion that is reversed on the baffle's two ends. In particular, the front side one or more sheets, such as sheets 112i, 112ii, may protrude out beyond the other one or more sheets, such as sheets 112iii, 112iv, on one end of the baffle. Optionally, then the back side one or more sheets, such as sheets 112iii, 112iv, protrude out beyond the front side one or more sheets, such as sheets 112i, 112ii, on the opposite end of the baffle. As will be appreciated by the following description, this may be employed to create an overlapped seal when the baffles are connected end to end in an installation. It will be apparent then that the overall length OL of the baffle may be longer than the lengths L of the sheets therein.

As will be appreciated by a comparison of the baffles and sheets of FIGS. 1A to 2C against those of FIGS. 3A to 3E, the dimensions of the baffle, sheets and flaps can vary. The dimensions can be selected depending on the desired size of the baffles, the installation orientation of the baffles and the way in which the flaps of the baffles bear and seal against the object against which they are to seal. For example, some baffles are intended to be installed with their flaps hanging vertically down. Some other baffles are intended to be installed on side walls with the flaps extending out horizontally.

The length Lf and width W of the flaps can be varied depending on the intended action of the flaps in the seal. The width W to length Lf ratio of the flaps may be 2:1 to 1:5. The width W to length Lf ratio of the flaps in FIG. 2A are between 1:1 and 1:5 and for example between about 1:1.5 to 1:2.5, while the width W to length Lf ratio of the flaps in FIG. 3E are between 2:1 and 1:2 and for example, between 1:0.5 and 1:1.5.

The baffle of FIGS. 1A to 1D has flaps with a greater degree of flex than the baffle of FIGS. 3A to 3E, but the flaps 116 of FIG. 3A to 3E have a greater ability to hold their horizontal position. As such, the baffle of FIGS. 3A to 3D is better than the baffle of FIGS. 1A to 1D at a side wall installation whether the length of the flap extends out horizontally.

It will also be appreciated by a comparison of the baffle of FIGS. 1A to 1D against the baffle of FIGS. 3A to 3D that the retainers 14, 114 can vary from baffle to baffle. The retainers can be selected to secure the sheets together and also to facilitate installation of the baffle on a mounting surface.

For example, retainer 14 of FIGS. 1A to 1D includes a pair of flat rods secured through the sheets and to each other with fasteners such as detents, rivets or bolts 20. In the illustrated embodiment, one rod is spaced back from the end of the baffle on one side and the opposite rod is spaced back from the other end of the baffle, so that the baffles can fit together in an end to end fashion.

The retainer 114 of FIG. 3A illustrates that a pair of plates can alternatively be used. In the plates of retainer 114, the overall height of the baffle can be extended well beyond the length of the sheets.

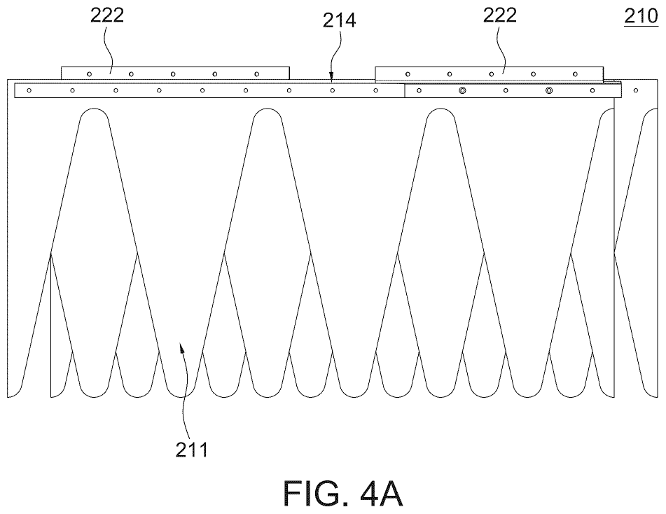

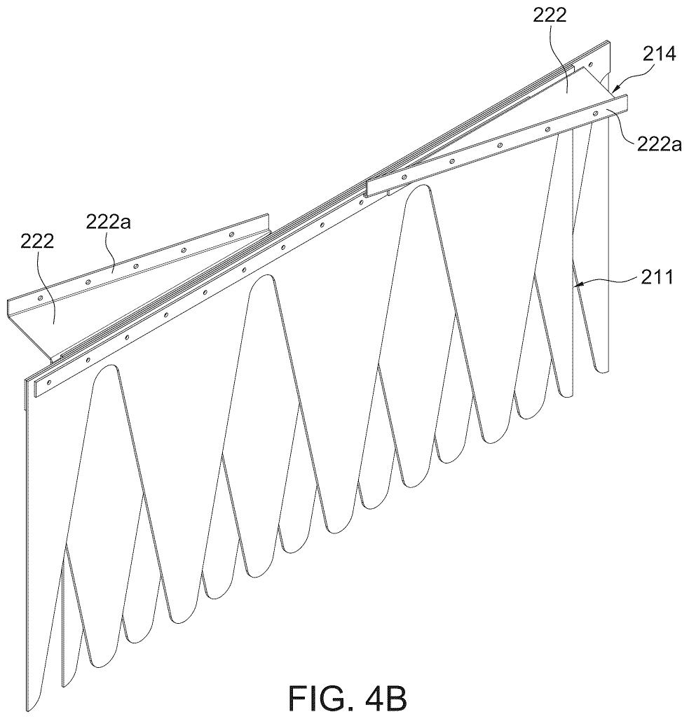

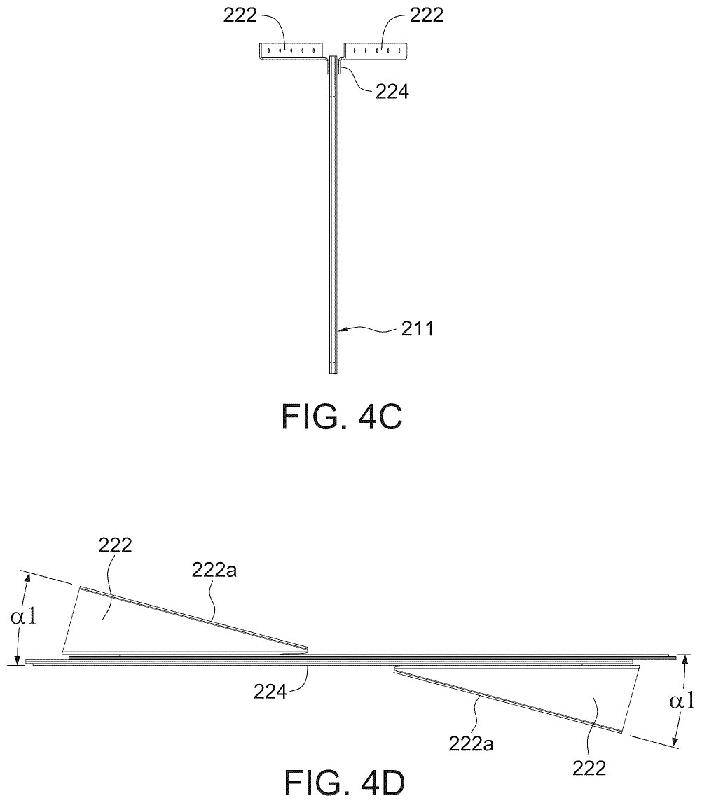

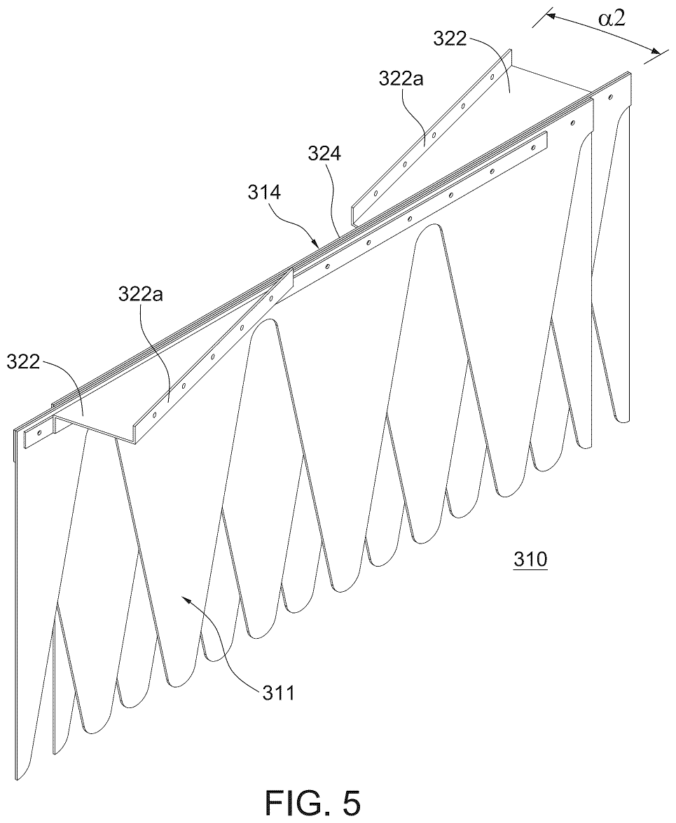

Other retainers are contemplated for special installations, as illustrated in FIGS. 4A to 4D and FIG. 5. The baffle 210 of FIGS. 4A to 4D and the baffle 310 of FIG. 5 are intended to be installed at an angle α1, α2 from a beam and the retainers 214,314 have flanges 222, 322 that extend at an angle from the main retainer clamps 224, 324.

In particular, with reference specifically to FIGS. 4A to 4D, the baffle seal portion 211 is clamped by main retainer clamp 214 that is a straight elongate member or pair of members. This main retainer clamp holds the sheets of the seal portion together and in a planar stacked configuration. Flanges 222 each have a mounting surface 222a on an angle α1 to an elongate axis defined along the length of main retainer clamp 214. The angles of the mounting surfaces are the same but one on one planar side of the baffle and the other protruding on the other side of the baffle, such that the mounting surfaces 222a are in line across the length of the baffle.

The baffle 310 of FIG. 5 is an opposite handed version of baffle 210 of FIG. 4A. Baffle 310 has a seal portion 311 and a retainer 314 including flanges 322 with mounting surfaces 322a that are at an opposite angle α2 compared to the mounting surfaces of the baffle of FIG. 4.

When the mounting surfaces 222a, 322a are secured to a straight mounting surface such as a beam, the mounting surfaces cause the seal portion of the baffle to be angled relative to the beam.

The angles α1 and α2 can be between 5 and 45 degrees.

Retainers 14, 114, 214, 314 are constructed of durable materials that are resistant to acid corrosion. The retainers for example can be formed of metal such as stainless steel or aluminum or strong, durable polymers.

Retainers 14, 114, 214, 314 can include or be coupled to movable or articulating mounts so that deflection/movement can be accommodated in operation.

There may be a biasing or backing member 26 to bias the sheets of the sealing portion together and in a selected orientation, such as vertically down. Member 26 may act as a stiffener to hold the sheets together in a selected position and hold baffle shape. The biasing or backing member may be coupled to or integral with the retainer.

The seal portions, retainers and biasing or backing members can be employed in various combinations, as desired.

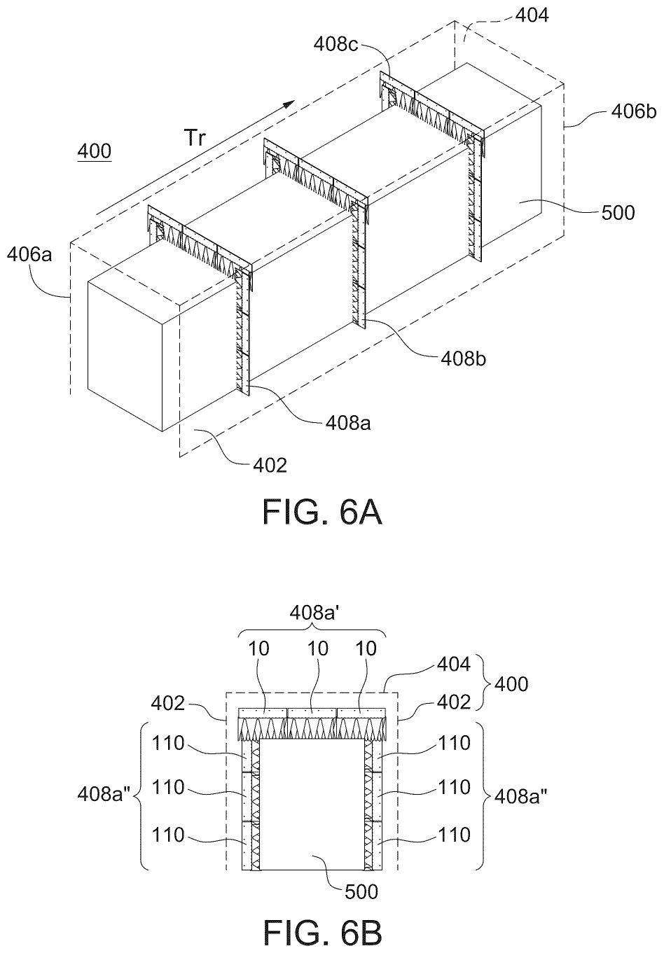

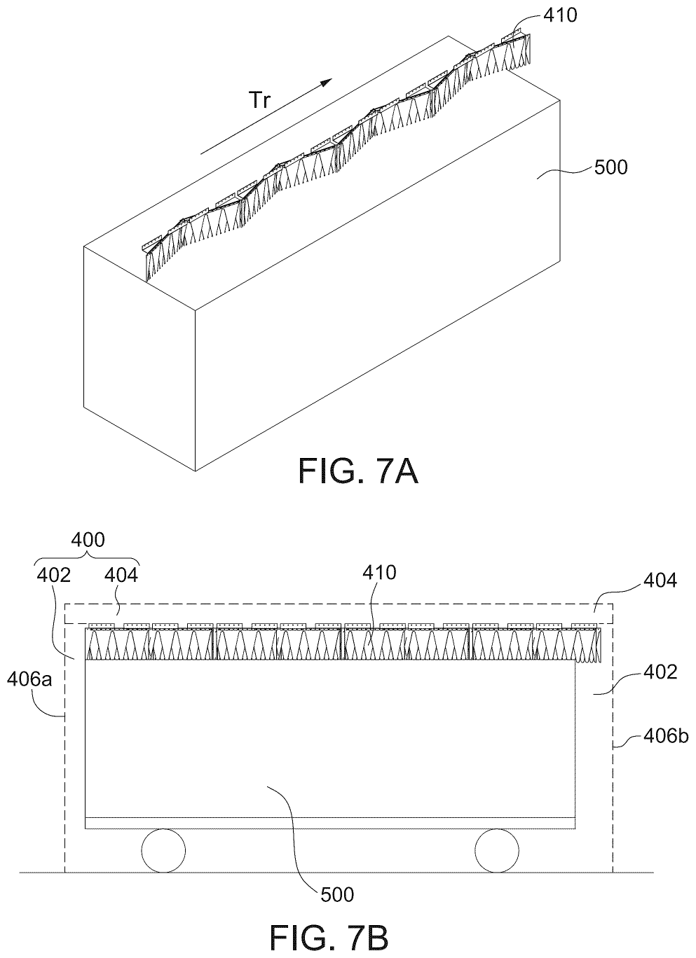

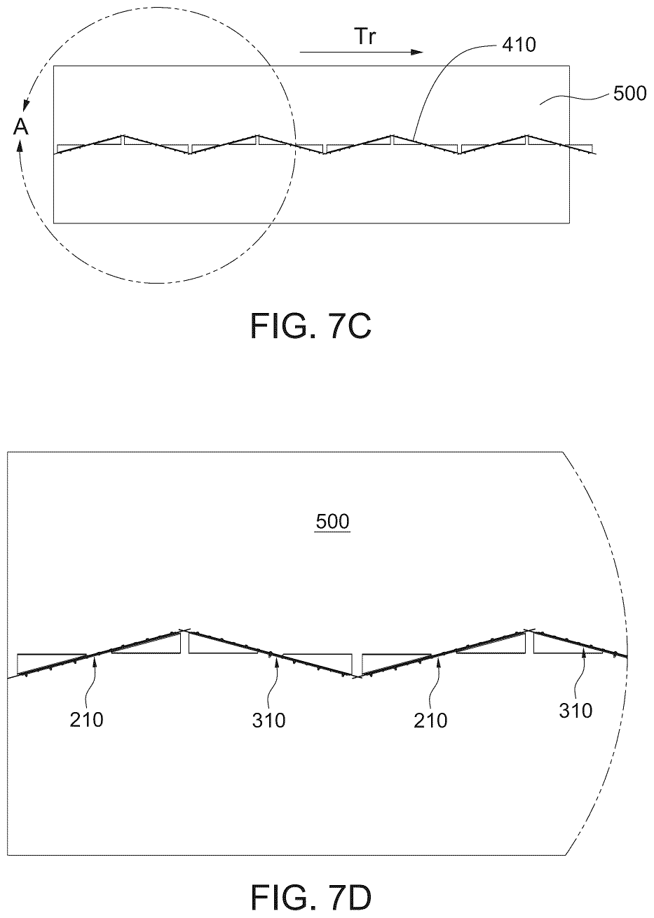

The baffles can be employed in various installations and environments. As noted, there is a need for durable baffles in wood kilns. With reference to FIGS. 6A to 7D, the baffles can be installed in a kiln.

A kiln 400 can have side walls 402 and a roof structure 404 (shown in phantom) that enclose an inner kiln chamber. There may be a doorway 406a to the inner chamber through which a charge of lumber may be moved into the chamber. The location of the doorway creates a path or duct through which a charge 500 may be introduced and moved through the chamber and therefore a direction of travel, arrow Tr, of the charge into the chamber. In one embodiment, there are two aligned doorways 406a, 406b on opposite ends of the kiln and the charge is moved axially through the doors, in one doorway and out the opposite doorway. In some embodiments, not shown, a kiln may include more than one axial pathway into/through the kiln inner chamber, so more than one charge can be treated within the kiln. In such an embodiment, more than one charge may be moved through the chamber.

Baffle installations can be used to segment the inner chamber into zones and can control the movement of the gaseous fluids, such as heated air, vapor, gases, etc. through the zones past and through the lumber charge. The baffles of each baffle installation deter fluids from leaking from zone to zone where the baffles are bearing against the lumber charge or its conveyance.

As illustrated in FIGS. 6A and 6B, baffle installations 408a, 408b, 408c may be mounted to extend along the inner surfaces of the chamber around the kiln transverse to the direction of travel, arrow Tr. Each baffle installation can include one or more baffles, wherein each baffle includes a sealing portion formed of a plurality of sheets with tapered flaps and V-shaped notches, such as one of the sheets described hereinabove. Each baffle also includes a retainer, which may be one of the retainers described hereinabove.

When charge 500 is moved through each installation, the installation creates a seal fully around the sides and across the upper surface of the charge. There may also be a baffle extending from the floor to seal against the underside of the charge or its conveyance, such as the underside of a railcar on which the charge is carried. Not to be limiting, but instead to explain, in the illustrated embodiment, baffle installations 408a, 408b, 408c create four zones in the kiln.

In the illustrated embodiment, using installation 408a as an example, the installation includes a ceiling portion 408a′ that extends across the ceiling of the roof structure and a side portion 408a″ on each side wall inner surface, each portion of which extends transverse to the direction of travel Tr. As such, the installation creates an arch.

Each portion 408a′ and 408a″ includes one or more baffles. It is advantageous to construct each baffle installation from a plurality of baffles aligned along their lengths, as this facilitates replacement of damaged areas of the installation without having to replace the entire installation.

In this illustrated embodiment, the ceiling portion 408a′ may be constructed of a plurality of aligned baffles 10 such as ones similar to those illustrated in FIG. 1A. The aligned baffles may be installed via their retainers on a ceiling mounting surface such as a transverse beam and may be positioned side edge to side edge. In one embodiment, where the baffles include a stepped end, the baffles may be overlapped at their side edges. The overall height OH of the baffles 10 in ceiling portion 408a′ is selected to be slightly more than the maximum gap between charge 500 and the ceiling. The flaps of the baffles hang down and bear against the upper surface of the charge when it is positioned in the arch. In particular, because the overall height OH of the baffles 10 in ceiling portion 408a′ is selected to be slightly more than the maximum gap between charge 500 and the ceiling, the tips of the flaps contact and bend against the surface of the charge, such that most if not all notches between flaps are closed.

In this illustrated embodiment, the side portions 408a″ may be constructed of a plurality of aligned baffles 110 such as ones similar to those illustrated in FIG. 3A. The aligned baffles may be installed via their retainers 114 on an interior side wall mounting surface such as a vertical support post. Baffles 110 may be positioned side edge to side edge. The overall height OH of the baffles 110, which when installed becomes a distance that the baffle extends laterally inwardly from the side wall, is selected to be slightly more than the maximum gap between charge 500 and the side wall. The flaps of the baffles are selected to hold their shape against gravity and bear against the side surface of the charge when it is positioned in the arch.

Because the overall height has a significant portion defined by the sealing portion, the baffle installations are configured to allow variations in charge dimensions/baffle interference through the sealing zones.

Gaseous fluids introduced into a zone, such as the space between installations 408a and 408b, are controlled by the baffles of the baffle installations to remain in that zone. The baffles create a seal that deters treatments in one zone from leaking through an installation into another zone. For example, the kiln can therefore be configured to apply different treatments in separate zones, for example progressively hotter temperatures, in the zones along path Tr.

As illustrated in FIGS. 7A to 7D, another baffle installation 410 may be mounted to extend along the inner surfaces of the chamber of the kiln parallel to the direction of travel, arrow T.

Baffle installation 410 can include one or more baffles, wherein each baffle includes a sealing portion formed of a plurality of sheets with tapered flaps and V-shaped notches, such as one of the sheets described hereinabove. Each baffle also includes a retainer, which may, for example, be one of the retainers described hereinabove.

When charge 500 is moved under installation 410, the installation creates a seal along the length of the upper surface of the charge. Baffle installation 410, as illustrated, creates two zones in the kiln. This installation therefore can force treatment fluids to pass through the charge rather than circumventing over the top of the charge. This installation can be used alone or can be combined with other longitudinal installations on the side wall or beneath the charge. Alternatively or in additional, the kiln can include installation 410 and one or more transverse installations.

As discussed above, it is advantageous to construct baffle installation 410 from a plurality of baffles positioned end to end, as this facilitates replacement of damaged areas of the installation without having to replace the entire installation.

While baffle installation 410 could be positioned in a straight line, parallel to direction Tr, the sealing properties are enhanced by installing the baffles end to end but out of axial alignment with each other. For example, baffle installation 410 may include a plurality of baffles positioned in a zig zag arrangement, with some angled left and others angled right relative to the direction of travel Tr. In particular, each baffle is installed with its length offset from the direction of travel Tr through the kiln, but butting against the end edge of another baffle.

This installation ensures that the angle of incidence of charge moving against flaps is not in line with the length of the baffle. Thus, all flaps in the baffle are all bent in the same direction when a charge is moved therepast. As such, this ensures that the flaps of the stacked sheets all remain in place sealed against the flaps of adjacent sheets.

In this illustrated embodiment, installation 410 may be constructed of a plurality of aligned baffles such as baffles 210 and 310 similar to those illustrated in FIGS. 4A and 5, respectively. The baffles 210, 310 may be installed via their retainers on a ceiling mounting surface such as a beam and may be positioned end edge to end edge. The overall height OH of the baffles in installation 410 is selected to be slightly more than the maximum gap between charge 500 and the ceiling. The flaps of the baffles hang down and bear against the upper surface of the charge when it is positioned under the installation.

The installation 410 may not be limited to baffles oriented L/R/L/R/L/R/L/R, as shown, but patterns can vary to suit travel path and load shape.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the scope of the claims. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

We claim:

1. A baffle, comprising:
a sealing portion including a first sheet of flexible sheet material and a second sheet of flexible sheet material overlying the first sheet of flexible sheet material to define a stack, each of the first sheet and the second sheet including a base edge, a plurality of flaps extending from the base edge and a V-shaped notch between each adjacent pair of flaps, the plurality of flaps of the first sheet being aligned with the V-shaped notches of the second sheet in the stack; and
a retainer coupled to the sealing portion, the retainer securing the first sheet and the second sheet along the base edges.

2. The baffle of claim 1, wherein each of the plurality of flaps extend from the base edge to a rounded tip.

3. The baffle of claim 1, wherein on at least one of the first sheet and the second sheet, an end flap of the plurality of flaps includes a side edge that extends perpendicularly from the base edge.

4. The baffle of claim 1, wherein the retainer includes a clamp for securing the plurality of sheets along the base edges, and a flange that extends at an angle from the clamp.

5. The baffle of claim 4, wherein the flange has a mounting surface that extends at an angle with respect to a long axis of the clamp.

6. The baffle of claim 1, wherein each of the first sheet and the second sheet is stiffer near the base edge than at tip portions of the plurality of flaps.

7. A baffle installation, comprising:
a first baffle and a second baffle, each of the first baffle and the second baffle having
a length extending from a first end to a second end;
a sealing portion including a plurality of sheets of flexible sheet material overlying one another in a stack, each of the plurality of sheets including a base edge and a plurality of flaps extending from the base edge and a V-shaped notch between each adjacent pair of flaps, the flaps of one sheet aligned with the notches of an adjacent sheet in the stack; and
a retainer coupled to the sealing portion, the retainer securing the plurality of sheets along the base edges;
the second end of the first baffle being adjacent to the first end of the second baffle.

8. The baffle installation of claim 7, wherein the second end of the first baffle is positioned at an angle with respect to the first end of the second baffle such that the first baffle and the second baffle are out of axial alignment with respect to each other.

9. The baffle installation of claim 7, wherein each of the first baffle and the second baffle has a ratio of flap width to flap length, the ratio of the flap width to the flap length being 2:1 to 1:5.

10. A kiln, comprising:
a chamber with a doorway;
the doorway being positioned to create a path through which a charge may be introduced to the chamber;
a baffle installation, disposed on an inner surface of the chamber, the baffle installation including:
a first baffle and a second baffle, each of the first baffle and the second baffle having
a length extending from a first end to a second end;
a sealing portion including a plurality of sheets of flexible sheet material overlying one another in a stack, each of the plurality of sheets including a base edge and a plurality of flaps extending from the base edge and a V-shaped notch between each adjacent pair of flaps, the flaps of one sheet aligned with the notches of an adjacent sheet in the stack; and
a retainer coupled to the sealing portion, the retainer securing the plurality of sheets along the base edges;
the second end of the first baffle being adjacent to the first end of the second baffle.

11. The kiln of claim 10, wherein a long axis of the baffle installation extends substantially parallel to the path.

12. The kiln of claim 11, wherein the second end of the first baffle is positioned at an angle with respect to the first end of the second baffle such that the first baffle and the second baffle are out of axial alignment with respect to each other.

13. The kiln of claim 10, wherein a long axis of the baffle installation extends transverse to an axis of the path.

14. A method for drying a charge, the method comprising:
inserting the charge into a chamber;
the chamber having a baffle installation according to claim 7 disposed therein, thereby segmenting the chamber into a first zone on a first side of the baffle installation and a second zone on a second side of the baffle installation;
the baffle installation being positioned to create a seal against the charge; and
flowing a fluid from the first zone through the charge into the second zone.

15. The method of claim 14 wherein the charge moves past the baffle installation while flowing the fluid.
